(19) United States
(12) Patent Application Publication
(10) Pub. No.: US 2012/0155381 A1
(43) Pub. Date: Jun. 21, 2012

(54) METHOD AND APPARATUS FOR USING A WIRELESS DEVICE WITH MULTIPLE RADIOS

(75) Inventors: Wayne W. Ballantyne, Coconut Creek, FL (US); Gustavo D. Leizerovich, Aventura, FL (US); Shahab M. Sayeedi, Naperville, IL (US)

(73) Assignee: MOTOROLA-MOBILITY, INC., Libertyville, IL (US)

(21) Appl. No.: 12/971,045

(22) Filed: Dec. 17, 2010

(51) Int. Cl. H04W 88/02

(52) U.S. Cl. 370/328

(57) ABSTRACT

A method and apparatus for operating a dual-modem wireless device is provided herein. During operation, a mobile unit is allowed to operate in both a single-radio and a dual-radio mode. The mobile unit is allowed to dynamically switch between a single-radio and a dual-radio mode depending on environmental parameters.

### FIELD OF THE INVENTION

The present invention relates generally to dual-modem wireless devices and in particular, to a method and apparatus for using a dual-modem wireless device.

### BACKGROUND OF THE INVENTION

As several wireless telecommunication standards have developed and matured, standards development organizations (SDOs) have recently standardized the behaviors of dual-modem mobile devices. These specifications facilitate handovers in heterogeneous technology networks for dual-modem mobiles (e.g., handover to a system employing a WiMAX standard to a system employing a 3GPP2 standard). For example, according to the WiMAX-3GPP2 interworking specifications, within each type of dual-modem device, there are two major implementation options: (1) so-called “Dual Radio”, where both transceivers (WiMAX and 3GPP2) can operate simultaneously, including simultaneous transmit, and (2) “single radio”, where there are still two WiMAX and 3GPP2 transceivers but only one is allowed to transmit at a time. The single radio scheme is sometimes referred to “1T-2R”, denoting that simultaneous receive is possible for the WiMAX and 3GPP2 receiver, but only one transmitter is active at a time. The dual radio scheme is sometimes referred to “2T-2R”, denoting that simultaneous receive is possible for the WiMAX and 3GPP2 receiver, and both transmitters may be active at the same time.

The advantages of dual-radio mode include: (1) simultaneous, timing independent access to both networks (2) ability for true Make before Break handover, and thus lower data application latency during handover. Access and registration to the secondary (target handover) network can occur while the mobile is in an active session on the primary network. Thus, in a situation where coverage in the active radio-access network (RAN) begins to fade, a parallel session can be established with the other heterogeneous RAN network (such as a 3GPP2 EV-DO network). When the first network coverage becomes unacceptable, its active service flows can be terminated just after new service flows on a target RAN becomes active. The net result is that a near-seamless data handover is achieved, and the user will not notice any gaps in real-time applications such as VoIP or Video Streaming.

The motivation for supporting a single-radio mode (i.e., dual receive, single transmit) is that the device cost will be somewhat cheaper, especially if shared antennas are used. There are other practical benefits to operating a single-radio device. For example, since the total peak radio battery current is equal to the sum of both modems transmit currents, (plus other currents not related to the modems), this may lead to a hardware reset if not accounted for, e.g., if the radio Battery Voltage falls to 2.7V. Otherwise, with proper software management, the End-of-life threshold for the (unloaded/lightly loaded) radio battery is raised, so the radio must shut off earlier, and the effective battery capacity is reduced in dual-radio mode.

As is evident, there are advantages to using a single-radio mode, and there are advantages to using a dual-radio mode. It would be advantageous to be able to switch between the two modes as environmental parameters change. Therefore a need exists for a method and apparatus for using a dual-modem wireless device that allows for switching between a dual-radio mode and a single-radio mode, and vice versa, when beneficial to do so.

### BRIEF DESCRIPTION OF THE DRAWINGS

FIG. 1 is a block diagram showing a mobile unit within a heterogeneous environment.

FIG. 2. is a block diagram of the mobile unit of FIG. 1.

FIG. 3 is a flow chart showing the operation of the mobile unit of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to alleviate the above-mentioned need, a method and apparatus for operating a dual-modem wireless device is provided herein. During operation, a dual-modem mobile unit is allowed to operate in both a single-radio and a dual-radio mode. The mobile unit is allowed to dynamically switch between a single-radio and a dual-radio mode depending on mobile unit and network conditions. This approach adds a small amount of cost to the mobile unit but provides multiple advantages during operation. For example, using a single-radio mode of operation all the time consumes more resources in the network, due to need for “reserving resources”, therefore a dual-radio mode conserves network resources. Additionally, using dual-radio mode all the time may not be feasible due to battery life issues, thus the ability to switch to a single-radio mode of operation allows for longer battery life. Additionally, using a dual-radio mode when mobile unit conditions permit, allows for reduced usage of Network resources and lower latency handover.

The present invention comprises a method for operating a dual-modem wireless device. The method comprises the steps of operating the dual-modem wireless device in a first mode of operation, wherein the first mode of operation comprises either a dual-radio mode of operation or a single-radio mode of operation, determining if a condition has been met, and operating the dual-modem wireless device in a second mode of operation differing from the first mode of operation when the condition has been met, wherein the second mode of operation comprises either a dual-radio mode of operation or a single-radio mode of operation.

The present invention additionally encompasses an apparatus comprising a plurality of modems operating in a first mode of operation, wherein the first mode of operation comprises either a dual-radio mode of operation or a single-radio mode of operation, logic circuitry or software determining if a condition has been met, and the plurality of modems operating in a second mode of operation differing from the first mode of operation when the condition has been met, wherein the second mode of operation comprises either a dual-radio mode of operation or a single-radio mode of operation.

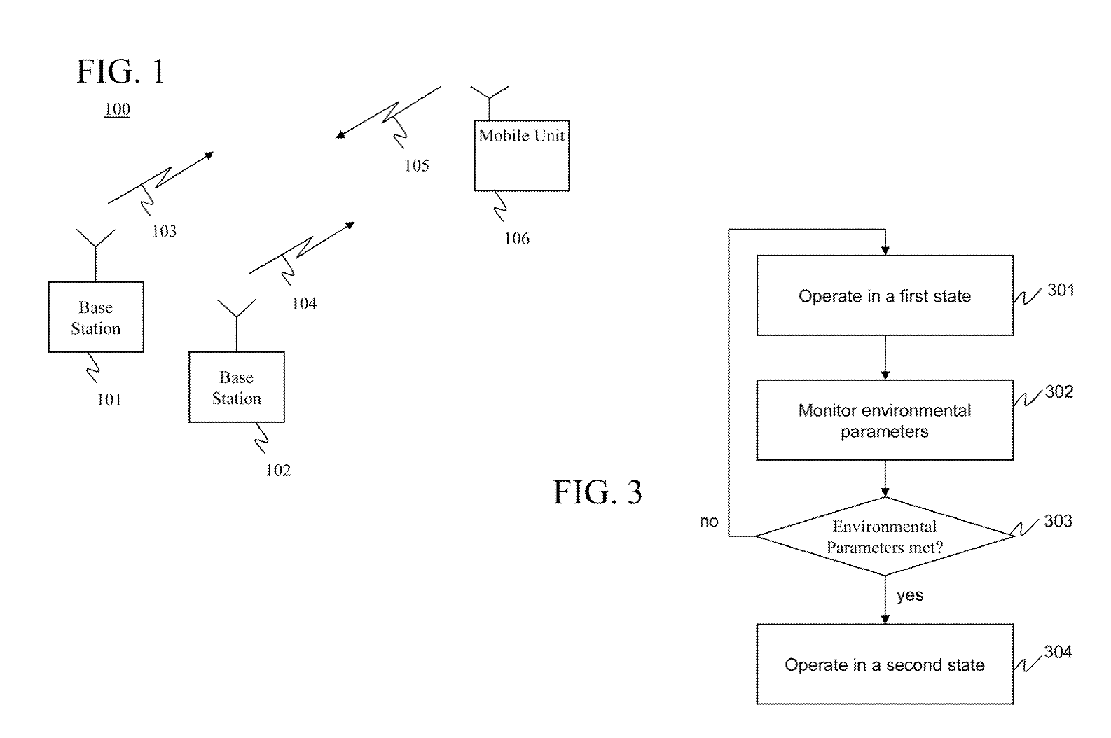

Turning now to the drawings, where like numerals designate like components, FIG. 1 is a block diagram showing a mobile unit within heterogeneous communication environment 100. As shown, communication environment 100 comprises at a minimum base station 101, base station 102, and mobile station 106. Base stations 101-102 may utilize any number of, but differing, communication system protocols. For example, base station 101 may utilize a WiMax communication system protocol as described in IEEE Std 802.16™-2009, “IEEE Standard for Local and Metropolitan area networks, Part 16: Air Interface for Broadband Access Networks”, while base station 102 utilizes a 3GPP2 communication system protocol.

Mobile unit 106 is preferably a dual-mode mobile unit that is capable of communication utilizing any number of communication system protocols. For example, mobile unit 106 may be capable of utilizing both the WiMax and 3GPP2 communication system protocols. As shown, remote unit 106 is communicating with base stations 101 and 102 via uplink communication signals 106, base station 101 is communicating with mobile unit 106 via downlink communication signals 104, and base station 102 is communicating with mobile unit 106 via downlink communication signals 105.

As described above, there are advantages for mobile unit 106 to operate in both a single-radio mode of operation and a dual-radio mode of operation. It would be advantageous to be able to switch between the two modes as environmental parameters change. Therefore, in a preferred embodiment of the present invention mobile unit 106 is allowed to switch between a dual-radio mode and single-radio mode of operation as environmental parameters dictate. Specifically, each mode of operation, environmental parameters, and RF Cutback are defined as follows:

Single-Radio Mode Operation—A mobile unit utilizing a single-radio mode will, at times, utilize one transmitter and two receivers simultaneously. A first receiver will be receiving communications from a first base station, when the mobile unit is registered in an active or idle state in the first network, utilizing a first communication system protocol, while a second receiver will be receiving network overhead communications from a second base station utilizing a second communication system protocol. The network overhead communication includes network access information should an unregistered mobile device attempt to access or handover to the second network for network service. Additionally, during single-radio mode, the mobile unit will comprise a first transmitter that will be transmitting to the first base station utilizing the first communication system protocol. It may also transmit to a second base station and core network by tunneling messages through the first base station, allowing it to operate in dual mode with a single transmitter. The mobile unit will also include a second transmitter capable of transmitting to the second base station utilizing the second communication system protocol, but the first transmitter and the second transmitter will never be active simultaneously.
Dual-Radio Mode Operation—A mobile unit utilizing a dual-radio mode will, at times, utilize two transmitters and two receivers simultaneously. A first receiver will be receiving communications from a first base station, when the mobile unit is registered in an active or idle state in the first network, utilizing a first communication system protocol, while a second receiver will be receiving communications from a second base station utilizing a second communication system protocol. The network overhead communication includes network access information should an unregistered mobile device attempt to access or handover to the second network for network service. Additionally, during dual-radio mode, the mobile unit will comprise a first transmitter that will be transmitting to the first base station utilizing the first communication system protocol. The mobile unit will additionally comprise a second transmitter transmitting to the second base station utilizing the second communication system protocol.
Environmental Parameters—Parameters that may cause a mobile unit to switch from a dual mode to a single mode of operation, and vice versa. Such parameters include radio battery voltage or remaining capacity, current radio transmit power for each transmitter, current radio user application type, RF cutback, or the presence or absence of a battery charger for the radio.
RF Cutback—The RF cutback indicates how much the actual transmit power is reduced relative to the maximum rated transmit power for a modem when the transmitter for the modem is actually activated.

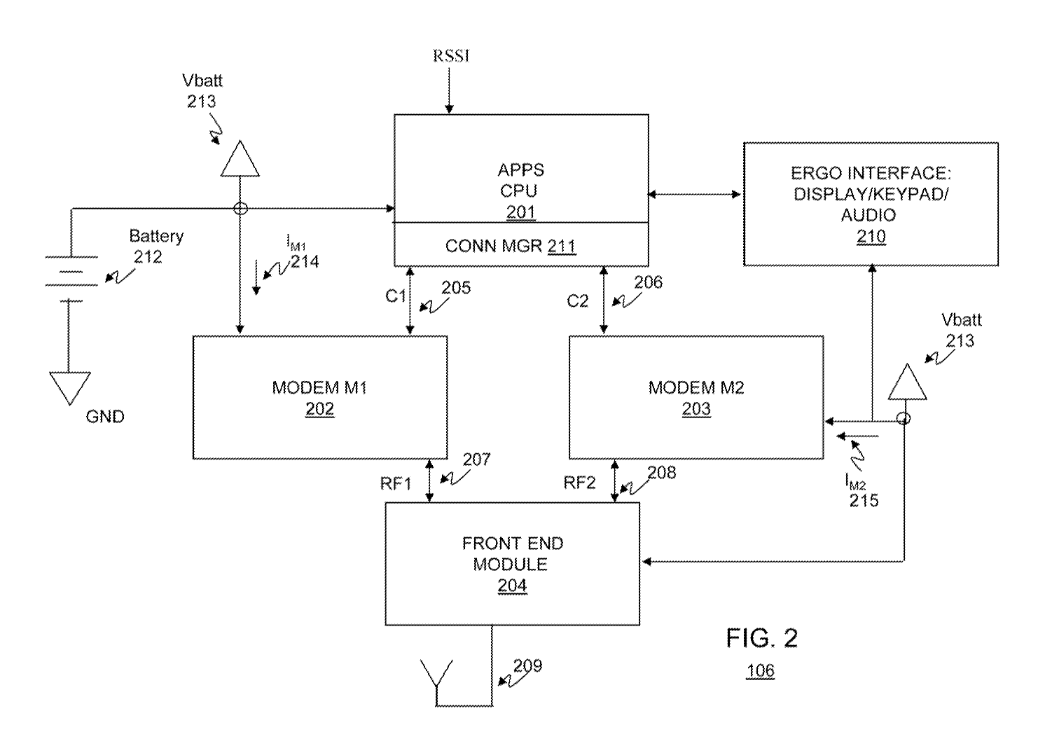

FIG. 2 is a block diagram of mobile unit 106 of FIG. 1. As shown, mobile unit 106 comprises application central processing unit (CPU) 201, and two modems M1 202, M2 203. CPU 201 preferably comprises a digital signal processor (DSP), general purpose microprocessor, a programmable logic device, or application specific integrated circuit (ASIC) and is utilized to accesses and instruct modems 202 and 203 on their mode of operation (e.g., dual-radio mode or single-radio mode). Modems 202 and 203 utilize differing wireless communication system protocols. For this example, modem 202 utilizes a WiMax communication system protocol, and modem 203 utilizes a communication system protocol defined by the Universal Mobile Telecommunications Standard (UMTS).

Communication interfaces C1 205 and C2 206 allow the CPU 201 to communicate with each modem 202 and 203. Communications include control information and data. A possible interface for C1 and C2 is the Secure Digital I/O (SDIO) or a Universal Serial bus (USB), both of which are high speed digital interfaces. Each modem 202, 203 has a radio frequency (RF) path 207, 208, to RF Front End Module 204, which in turn connects to the antenna system 209. The antenna system 209 may in fact consist of one antenna shared among modems 202 and 203 and Front End module 204, or separate antennas for each of modems 202 and 203. In some embodiments, the antenna system for modem 202 may in fact consist of two diversity antennas, and the antenna system for modem 203 may independently also consist of two diversity antennas.

Connection Management Software Layer 211 is an instruction set run by CPU 201 that is responsible for executing control of and feeding data to/from each modem. The control could include activating a single modem 202 or 203 and registering with the wireless network for each modem, starting an active session with a modem, monitoring signal conditions for a modem, and initiating handover-related behaviors in anticipation of needing to switch from modem 202 to modem 203, or visa versa.

RF Front End Module 204 will typically comprise elements such as RF switches, duplexers, diplexers, filters, RF PAs, RF LNAs, etc. In this embodiment, all the modules are assumed to be powered from battery 212 with output voltage 213. Battery voltage 213 is distributed to all electrical circuits in mobile unit 106, including modems 202 and 203, though in practice there will likely be regulators to convert the variable battery voltage (Vbatt) to a regulated voltage. Battery voltage 213 will decrease during periods of peak current, and if it decreases below a certain threshold (Vthr), the regulators or other sub-system components such as the RF Front End Module 204 will not continue to function properly. In response, CPU 201 (and in particular layer 211) will analyze Vbatt and instruct modems 202 and 203 to switch from a dual-radio mode of operation to a single-radio mode of operation when Vbatt is below a threshold. Connection manager 211 will also be aware of the Application type running on Application Processor 201. A switch between radio modes can then be made based on what current application is running. For example, CPU intensive applications requiring more power may necessitate a switch from a dual-radio mode of operation to a single-radio mode of operation when Vbatt is below a threshold.

It should be noted that while mobile unit 106 was described above switching between single modem and dual modem operation based on a battery voltage and/or current application running, in alternate embodiments of the present invention, this switch can be made based on other environmental parameters. For example, CPU 201 may switch modes of operation based on RF cutback levels for modem M1 and M2, or whether mobile unit 106 is connected to a charger (not shown).

FIG. 3 is a flow chart showing operation of mobile unit 106. At step 301, mobile unit 106 operates in first mode. At step 302, CPU 201 monitors environmental parameters. At step 303, CPU 201 (and in particular, software layer 211) determines if an environmental parameter has been met, and if so, the logic flow continues to step 304 where CPU 201 instructs modems 202 and 203 to operate in a second mode, differing from the first mode. If, however, at step 303 CPU 201 determines that an environmental parameter has not been met, the logic flow returns to step 301. It should be noted that steps 302 and 303 of FIG. 3 can take many forms, some of which will be described below.

### Radio Battery Voltage:

Mobile unit 106 may be operating in a dual-radio mode. At step 302 CPU 201 may monitor radio battery voltage. At step 303 CPU 201 may determine if the radio battery voltage has decreased below a predefined threshold (Vbatt_low). If Vbatt does fall below Vbatt_low, CPU 201 will instruct modems 202 and 203 to switch from a dual-radio mode of operation to a single-radio mode of operation (step 304).

### Power Cutback:

Mobile unit 106 may be operating in a single-radio mode. At step 302, CPU 201 may monitor for power cutback for each modem. At step 303 CPU 201 may determine if the power cutback has been detected above a predefined threshold. If detected above the predefined threshold, CPU 201 will instruct modems 202 and 203 to switch from a single-radio mode of operation to a dual-radio mode of operation (step 304). For example, if battery voltage is at its maximum, and there is power cutback for M1 and M2, then the radio will be able to go to a dual-radio mode of operation.

Wireless Device Plugged into a Charger:

Mobile unit 106 may be operating in a Single-radio mode. At step 302

CPU 201 may monitor whether or not the wireless device is plugged into a charger. At step 303 CPU 201 may determine that the wireless device is plugged into a charger. If the wireless device is plugged into a battery charger, CPU 201 will instruct modems 202 and 203 to switch from a Single-radio mode of operation to a Dual-radio mode of operation (step 304).

The converse may be true. In other words, mobile unit 106 may be operating in a Dual-radio mode. At step 302 CPU 201 may monitor whether or not the wireless device is plugged into a charger. At step 303 CPU 201 may determine that the wireless device is not plugged into a charger. If the wireless device is not plugged into a battery charger, CPU 201 will instruct modems 202 and 203 to switch from a Dual-radio mode of operation to a Single-radio mode of operation (step 304).

### Current Running Application:

Mobile unit 106 may be operating in a dual-radio mode. At step 302 CPU 201 may monitor the current application being utilized. At step 303 CPU 201 may determine if the current application belongs to a predefined set of applications. If the current application belongs to the predefined set of applications, CPU 201 will instruct modems 202 and 203 to switch from a dual-radio mode of operation to a single-radio mode of operation (step 304). For example, if the application type is File Transfer, the Connection Manager can decide to use, or give a preference to, Single Radio mode, even if the other environmental conditions would indicate that Dual Radio mode is possible. This would avoid the higher peak currents associated with Dual Radio mode.

While the invention has been particularly shown and described with reference to a particular embodiment, it will be understood by those skilled in the art that various changes in form and details may be made therein without departing from the spirit and scope of the invention. It is intended that such changes come within the scope of the following claims:

1. A method for operating a dual-modem wireless device, the method comprising the steps of:
operating the dual-modem wireless device in a first mode of operation, wherein the first mode of operation comprises either a dual-radio mode of operation or a single-radio mode of operation;
determining if a condition has been met; and
operating the dual-modem wireless device in a second mode of operation differing from the first mode of operation when the condition has been met, wherein the second mode of operation comprises either a dual-radio mode of operation or a single-radio mode of operation.

2. The method of claim 1 wherein the condition comprises a power cutback.

3. The method of claim 2 wherein the power cutback comprises how much a transmit power is reduced relative to a maximum rated transmit power for a modem when the transmitter for the modem is activated.

4. The method of claim 1 wherein the condition comprises wireless device environmental parameters.

5. The method of claim 1 wherein the condition comprises if a battery voltage has decreased below a predefined threshold, or if the battery voltage has increased above a predefined threshold.

6. The method of claim 5 wherein the step of operating the dual-modem wireless device in the first mode comprises the step of operating the dual-modem wireless device in a dual-radio mode and switching to a single-radio mode when the radio battery voltage has decreased below the predefined threshold.

7. The method of claim 1 wherein the condition comprises whether or not the wireless device is plugged into a charger.

8. The method of claim 7 wherein the step of operating the dual-modem wireless device in the first mode comprises the step of operating the dual-modem wireless device in a dual-radio mode and switching to a single-radio mode when the dual-modem wireless device is unplugged from the charger.

9. The method of claim 7 wherein the step of operating the dual-modem wireless device in the first mode comprises the step of operating the dual-modem wireless device in a single-radio mode and switching to a dual-radio mode when the dual-modem wireless device is plugged into the charger.

10. The method of claim 1 wherein the condition comprises if a current application being utilized belongs to a predefined set of applications.

11. The method of claim 10 wherein the condition comprises if the current application being utilized is a file transfer application, and wherein the dual-mode radio switches from a dual-radio mode of operation to a single-radio mode of operation when the current application comprises a file transfer operation.

12. The method of claim 1 wherein the dual-radio mode of operation comprises a mode of operation where two transmitters and two receivers are utilized simultaneously and the single-radio mode of operation comprises a mode of operation where only one transmitter is utilized at a time while two receivers are utilized simultaneously.

13. The method of claim 12 wherein the condition comprises a power cutback.

14. The method of claim 13 wherein the power cutback comprises how much a transmit power is reduced relative to a maximum rated transmit power for a modem when the transmitter for the modem is activated.

15. The method of claim 12 wherein the condition comprises environmental parameters.

16. The method of claim 12 wherein the condition comprises if a radio battery voltage has decreased below a predefined threshold.

17. The method of claim 16 wherein the step of operating the dual-modem wireless device in the first mode comprises the step of operating the dual-modem wireless device in a dual-radio mode and switching to a single-radio mode when the radio battery voltage has decreased below the predefined threshold.

18. The method of claim 12 wherein the condition comprises whether or not the wireless device is plugged into a charger.

19. The method of claim 18 wherein the step of operating the dual-modem wireless device in the first mode comprises the step of operating the dual-modem wireless device in a dual-radio mode and switching to a single-radio mode when the dual-modem wireless device is unplugged from the charger.

20. The method of claim 19 wherein the step of operating the dual-modem wireless device in the first mode comprises the step of operating the dual-modem wireless device in a single-radio mode and switching to a dual-radio mode when the dual-modem wireless device is plugged into the charger.

21. The method of claim 12 wherein the condition comprises if a current application being utilized belongs to a predefined set of applications.

22. The method of claim 21 wherein the condition comprises if the current application being utilized is a file transfer application, and wherein the dual-mode radio switches from a dual-radio mode of operation to a single-radio mode of operation when the current application comprises a file transfer operation.

23. An apparatus comprising:
a plurality of modems operating in a first mode of operation, wherein the first mode of operation comprises either a dual-radio mode of operation or a single-radio mode of operation;
logic circuitry or software determining if a condition has been met; and
the plurality of modems operating in a second mode of operation differing from the first mode of operation when the condition has been met, wherein the second mode of operation comprises either a dual-radio mode of operation or a single-radio mode of operation.
